(19) United States
(12) Patent Application Publication
(10) Pub. No.: US 2007/0057404 A1
(43) Pub. Date: Mar. 15, 2007

(54) Compression and injection molding applications utilizing glass fiber bundles

(76) Inventors: William G. Hager, Westerville, OH (US); David L. Shipp, Heath, OH (US); Leonard J. Adzlma, Pickerington, OH (US); Eugene V. Galloway, Anderson, SC (US); Fred C. Grube, Johnstown, OH (US); David T. Mercer, Newark, OH (US)

Correspondence Address: OWENS CORNING, 2790 COLUMBUS ROAD, GRANVILLE, OH, 43023, US

(21) Appl. No.: 11/319,896

(22) Filed: Dec. 28, 2005

Related U.S. Application Data
(63) Continuation-in-part of application No. 11/224,246, filed on Sep. 12, 2005.

(51) Int. Cl. B29C 45/00

(52) U.S. Cl. 264/257; 264/328.1

(57) ABSTRACT

Dried bundles of chopped glass fibers that may be used in compression and injection molding applications is provided. The chopped glass fiber bundles are formed of individual glass fibers positioned in a substantial parallel orientation. The dried chopped glass fiber bundles may be prepared by applying a size composition to attenuated glass fibers, splitting the fibers to obtain a desired bundle tex, chopping the wet glass bundles to a discrete length, and drying the wet glass bundles in a dielectric oven. Alternatively, the dried chopped glass bundles may be prepared by sizing attenuated glass fibers, passing the sized fibers through a heat transfer chamber where air heated by a bushing is drawn into the heat transfer chamber to dry the glass fiber bundles, splitting the dried, sized glass fiber bundles to obtain a desired bundle tex, and chopping the dried bundles of glass fibers.

### CROSS REFERENCE TO RELATED APPLICATIONS

This application is a continuation-in-part of U.S. patent application Ser. No. 11/224,246 entitled “Glass Fiber Bundles For Mat Applications And Methods of Making The Same” filed Sep. 12, 2005, the content of which is incorporated by reference in its entirety.

### TECHNICAL FIELD AND INDUSTRIAL APPLICABILITY OF THE INVENTION

The present invention relates generally to reinforced thermoplastic and thermoset composites, and more particularly, to dried bundles of chopped glass fibers that may be used as a replacement for glass forms conventionally utilized in compression or injection molding applications to form reinforced composites.

### BACKGROUND OF THE INVENTION

Typically, glass fibers are formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the wet fibers may be gathered into one or more strands, chopped into a desired length, and collected. The chopped strands may contain hundreds or thousands of individual glass fibers. The collected chopped glass strands may then be packaged in their wet condition as wet chopped fiber strands (WUCS) or dried to form dry chopped fiber strands (DUCS).

Chopped glass fibers are commonly used as reinforcement materials in thermoplastic and thermoset articles. For example, the dried chopped fiber strands may be mixed with a polymeric resin and supplied to a compression or injection molding machine to form a glass reinforced composite article. The chopped fiber strands may be mixed with powder, regrind, or pellets of a thermoplastic polymer resin in an extruder. For instance, the powder, regrind, or polymer pellets may be fed into a first port of a twin screw extruder and the dry chopped glass fibers may be fed into a second port of the extruder with the melted polymer to form a fiber/resin mixture. Alternatively, the polymer resin and chopped strand segments are dry mixed and fed together into a single screw extruder where the resin is melted, the integrity of the glass fiber strands is broken down, and the fiber strands are dispersed throughout the molten resin to form a fiber/resin mixture. The fiber/resin mixture may be fed directly into an injection molding machine, or, the fiber/resin mixture may be formed into pellets. The dry fiber strand/resin dispersion pellets may then be fed to a molding machine and formed into molded composite articles that have a substantially homogeneous dispersion of glass fiber strands throughout the composite article.

Dried chopped fiber strands are typically more expensive to manufacture than wet chopped strands because the dry fibers are generally dried and packaged in separate steps before being chopped. In addition, in compression and injection molded articles, the mechanical and impact performance are directly proportional to the glass content. Thus, it would be desirable to utilize a less expensive glass formation platform that would achieve an increased glass content in composites that require a high impact strength.

Bundles of dried chopped fibers formed from wet fibers have previously been manufactured. Some examples of the processes of forming these bundles of dried chopped fibers are described below.

U.S. Pat. No. 4,024,647 to Schaefer discloses a method and apparatus for drying and conveying chopped glass strands. Glass filaments are attenuated through orifices in a bushing and coated with a lubricant binder and/or size. The filaments are gathered into one or more strands and chopped. The wet, chopped fibers then falls onto a first vibratory conveyor. The vibrations of the first vibratory conveyor maintains the chopped strands in fiber bundles by keeping the bundles from adhering to each other. The chopped strands are then passed to a second vibratory conveyor and through a heating zone where the chopped strands are heated to reduce the moisture content to less than 0.1 percent by weight. Chopped strands of a desired length then pass through a foraminous portion of the second vibratory conveyor and into a collection package.

U.S. Pat. No. 5,055,119 to Flautt et al. describe an energy efficient process and apparatus for forming glass fiber bundles or strands. Glass fibers are formed from molten glass discharged from a heated bushing. The fibers are moved downwardly and a sizing is applied to the glass fibers by an applicator. To dry the glass fibers, air from around the bushing is passed beneath the bushing where it is heated by the heat of the bushing. The heated air is drawn into a chamber through which the glass fibers pass. The heat transfer contact causes the water or solvent in the sizing composition to be evaporated. The dried fibers are then gathered into a bundle. The bundles may subsequently be chopped.

U.S. Pat. No. 6,148,641 to Blough et al. describe a method and an apparatus for producing dried, chopped strands from a supply of continuous fiber strands. In the described method, chopped fiber strands are produced from one or more continuous strands by chopping the fiber strands in a chopping assembly, ejecting the chopped strands from an exit assembly into a transition chute directly into a drying chamber, collecting the chopped strands in the drying chamber, and at least partially drying the strands in the drying chamber.

Despite the existence of these dried chopped glass bundles, there remains a need in the art for a cost-effective and efficient process for increasing the glass fiber content and evenly dispersing the glass fibers in compression and injection molded composite parts.

### SUMMARY OF THE INVENTION

It is an object of the present invention to provide chopped glass fiber bundles that may be used as a replacement for conventional glass forms utilized in compression or injection molding applications. The chopped glass fiber bundles are formed of a plurality of individual glass fibers positioned in a substantially parallel orientation to each other. The glass fibers used to form the chopped fiber bundles may be any type of glass fiber. Although reinforcing fibers such as natural fibers, mineral fibers, carbon fibers, ceramic fibers, and/or synthetic fibers may be present in the chopped glass fiber bundles, it is preferred that all of the fibers in the chopped glass fiber bundles are glass fibers. The fibers are at least partially coated with a size composition that includes one or more film forming agents (such as a polyurethane film former, a polyester film former, and/or an epoxy resin film former), at least one lubricant, and at least one silane coupling agent (such as an aminosilane or methacryloxy silane coupling agent). The size on the glass fibers maintains bundle integrity during the formation and subsequent processing of the glass fiber bundles and assists in filamentizing the chopped glass fiber bundles during subsequent processing steps in order to provide an aesthetically pleasing look to the finished product.

It is also an object of the present invention to provide a method of forming chopped glass fiber bundles that may be used as a replacement for conventional glass forms utilized in compression and injection molding applications. A size composition including one or more film forming agents (such as a polyurethane film former, a polyester film former, and/or an epoxy resin film former), at least one lubricant, and at least one silane coupling agent (such as an aminosilane or methacryloxy silane coupling agent) is applied to attenuated glass fibers in a conventional manner. The sized glass fibers may be split into glass fiber strands containing a predetermined number of individual glass fibers. It is desirable that the glass fiber bundles have a bundle tex of about 20 to about 200 g/km. The glass fiber strands may then be chopped into wet chopped glass fiber bundles and dried to consolidate or solidify the sizing composition. Preferably, the wet bundles of fibers are dried in an oven such as a conventional dielectric (RF) oven, a fluidized bed oven such as a Cratec® oven (available from Owens Corning), or a rotary tray thermal oven to form the chopped glass fiber bundles.

It is also an object of the present invention to provide a method of forming chopped glass fiber bundles that utilizes a heat transfer chamber to adiabatically dry the wet, sized glass fibers. A size composition including one or more film forming agents (such as a polyurethane film former, a polyester film former, and/or an epoxy resin film former), at least one lubricant, and at least one silane coupling agent (such as an aminosilane or methacryloxy silane coupling agent) is applied to glass fibers attenuated from a bushing. The sized glass fibers may then be passed through a heat transfer chamber where air heated by the bushing is drawn into the heat transfer chamber to substantially dry the sizing on the glass fibers. The dried glass fibers exiting the heat transfer chamber may be split into glass fiber strands that contain a pre-selected number of individual glass fibers. It is desirable that the glass fiber bundles have a bundle tex of about 5 to about 500 g/km. The glass strands may be gathered together into a single tow prior to chopping the glass strands into chopped glass fiber bundles. In one exemplary embodiment, the chopped fiber bundles are further dried in a conventional dielectric (RF) oven, a fluidized bed oven such as a Cratec® oven (available from Owens Coming), or a rotary tray thermal oven.

It is an advantage of the present invention that the chopped glass fiber bundles may be formed at a faster rate of speed. Increasing the rate of speed that the chopped glass fiber bundles can be produced permits for a higher throughput and additional product that can be sold to customers.

It is another advantage of the present invention that the chopped glass fiber bundles can be formed with low manufacturing costs because the wet glass fibers can be dried in bulk.

It is yet another advantage of the present invention that the chopped glass fibers bundles are formed in one step and dried in a container that may then be shipped to mat making facilities or to customers that use the chopped glass fibers in compression or injection molding applications.

It is a further advantage that the chopped glass fiber bundles may be used directly in compression or injection molding applications without modification to the bundles.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a chopped strand bundle according to an exemplary embodiment of the present invention;

FIG. 2 is a flow diagram illustrating steps of an exemplary process for forming glass fiber bundles according to at least one embodiment of the present invention;

FIG. 3 is a schematic illustration of a processing ling for forming dried chopped strand bundles according to one exemplary embodiment of the present invention;

FIG. 3a is a flow diagram illustrating an exemplary embodiment of the present invention in which the chopped fiber bundles are collected wet and then dried en masse;

FIG. 4 is a schematic illustration of a processing line for forming dried chopped strand bundles according to at least one other exemplary embodiment of the invention;

FIG. 5 is a graphical illustration of IZOD notched impact strength of bulk molding compounds made with glass fibers sized with sizing compositions according to the present invention versus control at zero (0) degrees;

FIG. 6 is a graphical illustration of IZOD notched impact strength of bulk molding compounds made with glass fibers sized with sizing compositions according to the present invention versus control at 90 degrees.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. The terms “top”, “bottom”, “side”, “upper”, “lower” and the like are used herein for the purpose of explanation only. It will be understood that when an element is referred to as being “on,” another element, it can be directly on or against the other element or intervening elements may be present. The terms “sizing”, “size”, “sizing composition”, and “size composition” may be interchangeably used herein. The terms “strand” and “bundle” may also be used interchangeably herein. In addition, the terms “sheet molding compound” and “sheet molding compound material” and “bulk molding compound” and “bulk molding compound material” may respectively be used interchangeably.

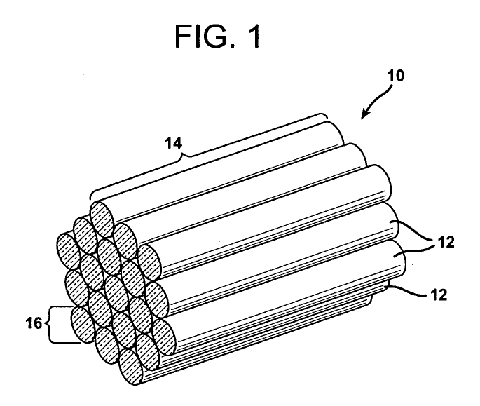

The present invention relates to chopped glass fiber bundles that may be used as a replacement for conventional glass forms utilized in compression and injection molding applications and to processes for forming such chopped glass fiber bundles. An example of a chopped glass fiber bundle according to the present invention is depicted generally in FIG. 1. As shown in FIG. 1, the chopped glass fiber bundle 10 is formed of a plurality of individual glass fibers 12 having a diameter 16 and a length 14. The individual glass fibers 12 are positioned in a substantially parallel orientation to each other in a tight knit or “bundled” formation. As used herein, the phrase “substantially parallel” is meant to denote that the individual glass fibers 12 are parallel or nearly parallel to each other.

The glass fibers used to form the chopped fiber bundles may be any type of glass fiber, such as A-type glass fibers, C-type glass fibers, E-type glass fibers, S-type glass fibers, E-CR-type glass fibers (e.g., Advantex® glass fibers commercially available from Owens Corning), wool glass fibers, or combinations thereof. In at least one preferred embodiment, the glass fibers are wet use chopped strand glass fibers (WUCS). Wet use chopped strand glass fibers may be formed by conventional processes known in the art. It is desirable that the wet use chopped strand glass fibers have a moisture content of from about 5 to about 30%, and even more desirably a moisture content of from about 5 to about 15%.

The use of other reinforcing fibers such as natural fibers, mineral fibers, carbon fibers, ceramic fibers, and/or synthetic fibers such as polyester, polyethylene, polyethylene terephthalate, polypropylene, and/or polyparaphenylene terephthalamide (sold commercially as Kevlar®) in the bundles of fibers 10 is considered to be within the purview of the invention. As used herein, the term “natural fiber” is meant to indicate plant fibers extracted from any part of a plant, including, but not limited to, the stem, seeds, leaves, roots, bast, or phloem. However, it is preferred that all of the fibers in the bundles 10 are glass fibers.

It is to be appreciated that reference is made herein to glass fiber bundles 12, a preferred embodiment of the invention. However, it is within the purview of the present invention to form the fiber bundles of the present invention entirely of a reinforcement fiber other than glass, such as the any one of the natural and synthetic fibers listed above. In addition, it is also to be appreciated that the fiber bundles may be formed of a combination of glass fibers and thermoplastic fibers. For example, a glass fiber bushing and a thermoplastic fiber bushing could be placed in close proximity, the glass fibers and thermoplastic fibers may be pulled together, and then chopped and dried (e.g., in-line) as described below to yield mixed fiber bundles. Such mixed glass/thermoplastic bundles may be shipped and molded without any additional additives to form a glass reinforced composite.

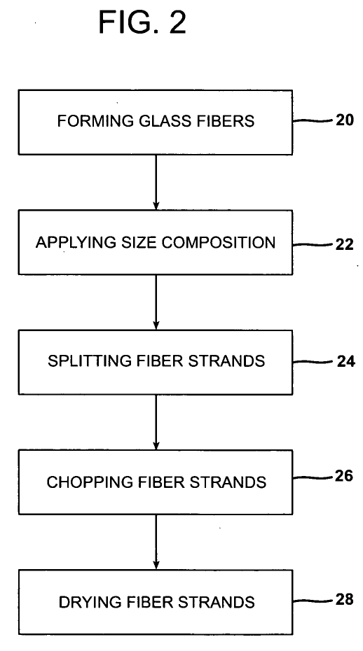

In one exemplary embodiment, shown generally in FIG. 2, the process of forming the chopped glass fiber bundles 10 includes forming glass fibers (Step 20), applying a size composition to glass fibers (Step 22), splitting the fibers to obtain a desired bundle tex (Step 24), chopping wet fiber strands to a discrete length (Step 26), and drying the wet strands (Step 28) to form the chopped glass fiber bundles.

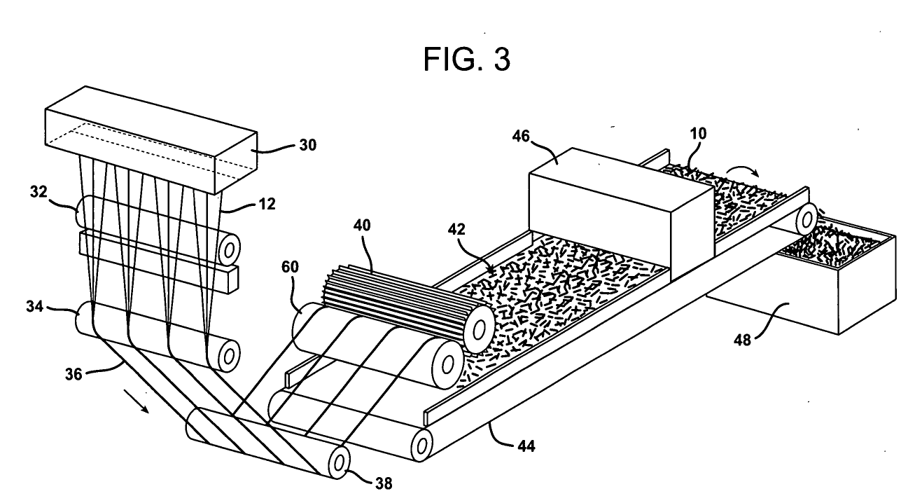

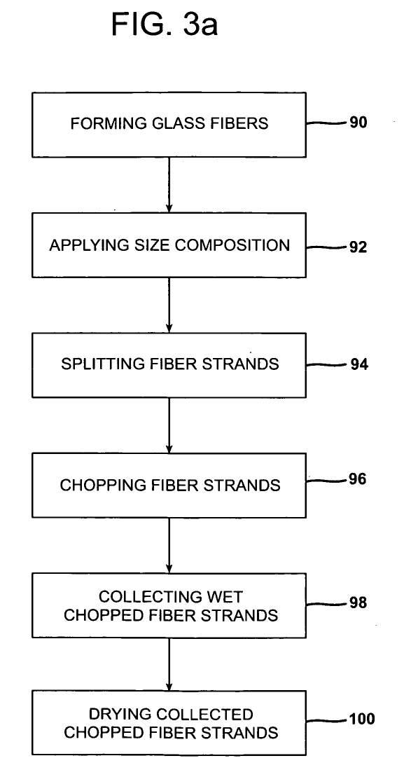

As shown in more detail in FIG. 3, glass fibers 12 may be formed by attenuating streams of a molten glass material (not shown) from a bushing or orifice 30. The attenuated glass fibers 12 may have diameters of about 6 to about 30 microns, preferably about 10 to about 16 microns. After the glass fibers 12 are drawn from the bushing 30, an aqueous sizing composition is applied to the fibers 12. The sizing may be applied by conventional methods such as by the application roller 32 shown in FIG. 3 or by spraying the size directly onto the fibers (not shown). The size protects the glass fibers 12 from breakage during subsequent processing, helps to retard interfilament abrasion, and ensures the integrity of the strands of glass fibers, e.g., the interconnection of the glass filaments that form the strand. In the present invention, the size on the glass fibers 12 also maintains bundle integrity during the formation and subsequent processing of the glass fiber bundles 10, such as in compression or injection molding processes.

The size composition applied to the glass fibers 12 includes one or more film forming agents (such as a polyurethane film former, a polyester film former, and/or an epoxy resin film former), at least one lubricant, and at least one silane coupling agent (such as an aminosilane or methacryloxy silane coupling agent). When needed, a weak acid such as acetic acid, boric acid, metaboric acid, succinic acid, citric acid, formic acid, and/or polyacrylic acids may be added to the size composition to assist in the hydrolysis of the silane coupling agent. The size composition may be applied to the glass fibers 12 with a Loss on Ignition (LOI) of from about 0.05 to about 10% on the dried fiber. LOI may be defined as the percentage of organic solid matter deposited on the glass fiber surfaces.

Film formers are agents which create improved adhesion between the glass fibers 12, which results in improved strand integrity. Suitable film formers for use in the present invention include polyurethane film formers, epoxy resin film formers, and unsaturated polyester resin film formers. Specific examples of film formers include, but are not limited to, polyurethane dispersions such as Neoxil 6158 (available from DSM); polyester dispersions such as Neoxil 2106 (available from DSM), Neoxil 9540 (available from DSM), and Neoxil PS 4759 (available from DSM); and epoxy resin dispersions such as PE-412 (available from AOC), NX 9620 (available from DSM), Neoxil 0151 (available from DSM), Neoxil 2762 (DSM), NX 1143 (available from DSM), AD 502 (available from AOC), Epi Rez 5520 (available from Hexion), Epi Rez 3952 (available from Hexion), Witcobond W-290 H (available from Chemtura), and Witcobond W-296 (available from Chemtura). The film former(s) may be present in the size composition from about 5 to about 95% by weight of the active solids of the size, preferably from about 15 to about 95% by weight of the active solids, and even more preferably from about 40 to about 80% by weight of the active solids.

The size composition also includes one or more silane coupling agents. Silane coupling agents enhance the adhesion of the film forming agent(s) to the glass fibers 12 and to reduce the level of fuzz, or broken fiber filaments, during subsequent processing. Examples of silane coupling agents which may be used in the present size composition may be characterized by the functional groups amino, epoxy, vinyl, methacryloxy, ureido, isocyanato, and azamido. Non-limiting examples of suitable coupling agents for use in the size composition include γ-aminopropyltriethoxysilane (A-1100 available from General Electric), methacryloxypropyltriethoxysilane (A-174 available from General Electric), n-phenyl- γ-aminopropyltrimethoxysilane (Y-9669 available from General Electric), polyazamide silylated aminosilane (A-1387 available from General Electric), bis-(α-trimethoxysilylpropyl) amine (A-1170 available from General Electric), and bis-silane (available as Y-9805 from General Electric). The silane coupling agent may be present in the size composition in an amount of from about 0.05 to about 80% by weight of the active solids in the size composition, preferably in an amount from about 1.5 to about 15% by weight of the active solids, and even more preferably, in an amount of from about 3 to about 15% by weight of the active solids.

In addition, the size composition may include at least one lubricant to facilitate manufacturing. The lubricant may be present in the size composition in an amount of from about 0 to about 15% by weight of the active solids in the size composition. Preferably, the lubricant is present in an amount of from about 0.05 to about 10% by weight of the active solids. Although any suitable lubricant may be used, examples of lubricants suitable for use in the size composition include, but are not limited to, stearic ethanolamide, sold under the trade designation Lubesize K-12 (available from AOC); PEG 400 MO, a monooleate ester having about 400 ethylene oxide groups (available from Cognis); and Emery 6760 L, a polyethyleneimine polyamide salt (available from Cognis). In addition, additives such as Emerest 2620, Emerest 2634, Emerest 2648, Emerest 2640, Emerest 2661, Emerest 2326, Tridet 2644, Emerlube 7440, Tryfac 5552, Tryfac 5576, Trycol® 5941, Trycol® 5993-A, Trycol® 5950, Trycol® 5999, Trycol® 5971, Trycol® 5964 (all of which are available commercially from Cognis), Citroflex A4 (commercially available from Morflex), LONZEST SMS and LONZEST SMS-20 (both are available from Lonza Chemical Company), and/or Paraffin 2280 (available commercially from Adert) may be added to the size composition to improve wet out of the glass fiber bundles in further processing steps, such as at a customer's facility.

It has been discovered that certain families of chemistry in combination are especially effective in causing the chopped glass fiber bundles 10 to remain in a bundle form during subsequent processing. For example, urethane-based film forming dispersions in combination with aminosilanes, such as, for example, γ-aminopropyltriethoxysilane (sold as A-1100 by General Electric) are effective in the size composition to keep the individual glass fibers 12 bundled together. Adding an additive such as a urethane-acrylic or polyurethane-acrylic alloy such as Witcobond A-100 to the urethane-based sizing composition has also been found to help maintain bundle integrity. It has also been discovered that a polyvinylacetate such as Celenese 2828 works well in combination with urethane film formers such as Witcobond W-290H or W-296 to maintain bundle integrity.

Additionally, epoxy-based film former dispersions in combination with epoxy curatives are effective sizing compositions for use in the present invention. In particular, an epoxy-based film former such as Epi-Rez 5520 and an epoxy curative such as DPC-6870 available from Resolution Performance Products forms an effective sizing composition, particularly in combination with a methacryloxy silane such as methacryloxypropyltriethoxysilane (commercially available as A-174 from General Electric).

Further, unsaturated polyester resin film formers have been found to be effective in forming a useful sizing composition. For example, an unsaturated polyester resin film former such as PE-412 (an unsaturated polyester in styrene that has been emulsified in water (AOC)) or Neoxil PS 4759 (available from DSM) are effective sizes for use in the present invention. Unsaturated polyester film formers may be used alone or in combination with a benzoyl peroxide curing catalyst such as Benox L-40LV (Norac Company, Inc.). The benzoyl peroxide curing catalyst catalyzes the cure (crosslinking) of the unsaturated polyester resin and renders the film surrounding the glass fibers water resistant.

The sizing composition may optionally contain conventional additives including antifoaming agents such as Drew L-139 (available from Drew Industries, a division of Ashland Chemical), antistatic agents such as Emerstat 6660A (available from Cognis), surfactants such as Surfynol 465 (available from Air Products), Triton X-100 (available from Cognis), and/or thickening agents. Additives may be present in the size composition from trace amounts (such as approximately 0.1% by weight of the active solids) up to about 5% by weight of the active solids.

Turning back to FIG. 3, after the glass fibers 12 are treated with the sizing composition, they are gathered and split into fiber strands 36 having a specific, desired number of individual glass fibers 12. The splitter shoe 34 splits the attenuated, sized glass fibers into fiber strands 36. The glass fiber strands 36 may optionally be passed through a second splitter shoe (not shown) prior to chopping the fiber strands 36. The specific number of individual glass fibers 12 present in the fiber strands 36 (and therefore the number of splits of the glass fibers 12) will vary depending on the particular application for the chopped glass fiber bundles 10 and the number of orifices present on the bushing (e.g., 2000 or as many as 5800 orifices could be present on a bushing). For example, assuming that a bushing has 4000 orifices for attenuating glass fibers, it would be necessary to split the attenuated glass fibers 40 ways to achieve a bundle of glass fibers that contains 100 fibers. The bundle tex of that particular bundle of glass fibers depends on the diameter of the glass fibers forming the bundle. In the example given above where the fiber bundles contain 100 individual glass fibers, if the fiber diameter of the glass fibers is 12 microns, the calculated bundle tex is 29. If the fiber diameter is 16 microns, the calculated bundle tex is 51 g/km. It is desirable that the glass fibers 12 are split into bundles of fibers that have a specific number of individual fibers to achieve a bundle tex of about 5 to about 500 g/km, preferably from about 30 to about 50 g/km.

The fiber strands 36 may be passed from the gathering shoe 38 to a chopper 40/cot 60 combination where they are chopped into wet chopped glass fiber bundles 42 having a length of approximately about 0.125 to about 3 inches, and preferably about 0.25 to about 1.25 inches. The wet, chopped glass fiber bundles 42 may fall onto a conveyor 44 (such as a foraminous conveyor) for conveyance to a drying oven 46. Alternatively, the wet bundles of chopped glass fibers 42 may be collected wet and stored in a container (not illustrated) for use at a later time.

In a further alternate embodiment shown generally in FIG. 3a, the glass fibers are formed (Step 90), the size composition is applied (Step 92), and the glass fibers are split to obtain a desired bundle tex (Step 94). The wet fiber strands are then chopped to a desired length (Step 96) and collected wet (Step 98). The wet bundles of chopped glass fibers are then collected in a container (Step 100) and the container containing the wet bundles of chopped glass fibers is passed through a drying oven, such as a dielectric oven, to dry the chopped strand fibers en masse. The container may then be shipped to mat making facilities or to customers that use the chopped glass fibers in compression or injection molding applications.

As shown in FIG. 3, the bundles of wet, sized chopped fiber bundles 42 may then be dried to consolidate or solidify the sizing composition. Preferably, the wet bundles of fibers 42 are dried in an oven 46 such as a conventional dielectric (RF) oven, a fluidized bed oven such as a Cratec® oven (available from Owens Corning), or a rotary tray thermal oven to form the chopped glass fiber bundles 10. The dried chopped glass fiber bundles 10 may then be collected in a collection container 48. In exemplary embodiments, greater than (or equal to) about 99% of the free water (i.e., water that is external to the chopped fiber bundles 42) is removed. It is desirable, however, that substantially all of the water is removed by the drying oven 46. It should be noted that the phrase “substantially all of the water” as it is used herein is meant to denote that all or nearly all of the free water from the fiber bundles 42 is removed.

In at least one exemplary embodiment, the wet bundles of glass fibers 42 are dried in a conventional dielectric (RF) oven. The dielectric oven includes spaced electrodes that produce alternating high-frequency electrical fields between successive oppositely charged electrodes. The wet bundles of glass fibers 42 pass between the electrodes and through the electrical fields where the high alternating frequency electrical fields act to excite the water molecules and raise their molecular energy to a level sufficient to cause the water within the wet chopped fiber bundles 42 to evaporate.

Dielectrically drying the bundles of wet glass fibers 42 enhances fiber-to-fiber cohesion and reduces bundle-to-bundle adhesion. The dielectric energy penetrates the wet bundles of chopped glass fibers 42 evenly and causes the water to quickly evaporate, helping to keep the wet glass bundles 42 separated from each other and reduce or eliminate “blocking” where the size on a bundle of fibers bundles intermingle with adjacent bundles of fibers so that when the size on the fibers is dry, the fiber bundles are stuck together as a bulk of fibers. In conventional thermal drying, the size dries from the outside-in, and, as a result, contact between fiber bundles would tend to bond adhesively to each other. Although not wishing to be bound by theory, it is believed that the water contained within the bundles 42 in the present invention is driven out in a way that causes the size to wick into the bundle interior first and set later, allowing the bundles 42 to remain in an individualized bundle form.

Additionally, the dielectric oven permits the wet glass fiber bundles 42 to be dried with no active method of fiber agitation as is conventionally required to remove moisture from wet fibers. This lack of agitation reduces or eliminates the attrition or abrasion of fibers as is commonly seen in conventional fluidized bed and tray drying ovens due to the high air flow velocities within the ovens and the mechanical motion of the fibrous material in the beds. In addition, the lack of agitation greatly increases the ability of the dielectric oven to maintain the glass fibers in bundles and not filamentize the glass fiber strands as in aggressive conventional thermal processes. Additionally, the dielectric oven allows the wet glass fiber bundles 42 to be dried for a shorter period of time and at lower temperatures than conventional thermal ovens. Further, the final color of products produced using the dielectrically dried glass fiber bundles is whiter than products formed from conventional thermally dried glass fibers.

In alternative embodiments, the wet chopped glass fiber bundles 42 may be dried in a fluidized bed oven such as a Cratec® oven or in a rotating tray oven. In both the Cratec® drying oven and rotating try oven, the wet chopped glass fiber bundles 42 are dried and the sizing composition on the fibers is solidified using a hot air flow having a controlled temperature. The dried fiber bundles 10 may then passed over screens to remove longs, fuzz balls, and other undesirable matter before the chopped glass fiber bundles 10 are collected. In addition, the high oven temperatures that are typically found in Cratec® and rotating tray ovens allow the size to quickly cure to a very high level (degree) of cure which reduces occurrences of premature filamentization.

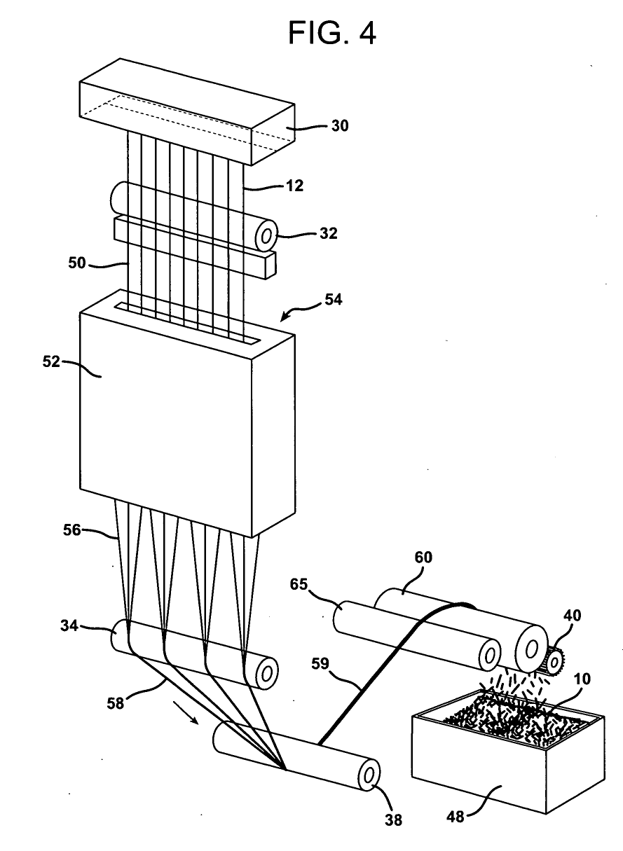

In another embodiment of the present invention for producing chopped glass fiber bundles depicted generally in FIG. 4, glass fibers 12 are attenuated from a bushing 30. An aqueous sizing composition as described in detail above is applied to the attenuated glass fibers 12 to form wet sized glass fibers 50. The sizing may be applied by conventional methods such as by an external application roller 32 or by spraying the size directly onto the glass fibers 12 (not shown). It is considered to be within the purview of the invention to position a size applicator internally within the heat transfer chamber 52. The wet sized glass fibers 50 then enter the heat transfer chamber 52 and ambient air is drawn into the uppermost end 54 of the heat transfer chamber 52 from circumferentially around the bushing 30.

As shown in FIG. 4, the heat transfer chamber 52 extends beneath the size applicator 32 and is positioned with the uppermost end 54 of the heat transfer chamber 52 in a sufficiently close proximity to the bushing 30 so that the air being drawn into the uppermost end 54 of the heat transfer chamber 52 is heated by the extreme heat generated by the bushing 30. In addition, the heat transfer chamber 52 is essentially circumferentially disposed about the sized glass fibers 50 so that the heated air may evaporate any water or solvent present in the size composition on the wet glass fibers 50. The heat transfer chamber 52 extends downwardly from the size applicator 32 a distance that is sufficient to dry or substantially dry the wet sized glass fibers 50. In a preferred embodiment, the moisture content of the glass fibers 50 is less than about 0.05%. The wet glass fibers 50 travel through the heat transfer chamber 52 and exit the chamber 52 as dried glass fibers 56. Such an adiabatic process is described in detail in U.S. Pat. No. 5,055,119 to Flautt et al., the content of which is hereby incorporated by reference in its entirety.

The dried sized glass fibers 56 are then gathered and split into dried fiber strands 58 having a specific, desired number of individual glass fibers 12. A splitter shoe 34 splits the dried sized glass fibers 56 into dried fiber strands 58, which may then be gathered by a gathering shoe 38 into a single tow 59 for chopping. It is to be appreciated that the splitter shoe 34 may be positioned internally (not illustrated) in the heat transfer chamber 52 to split the wet glass fibers 50 into fiber strands prior to exiting the heat transfer chamber 52. In this situation, the gathering shoe 38 may or may not be positioned within the heat transfer chamber 52. It is also to be appreciated that the splitter shoe 34 may be positioned between the size applicator 32 and the heat transfer chamber 52 to split the glass fibers 12 prior to entering the heat transfer chamber 52 (not shown).

The tow of combined glass fiber strands 59 may be chopped by a conventional cot 60 and cutter 40 combination to form the dried chopped fiber bundles 10. An idler wheel 65 may be positioned adjacent to the cot 60 to adjust the strand tension on the cot 60. As described above, the dried chopped fiber bundles 10 may have a length of about 0.125 to about 3 inches, and preferably a length of about 0.25 to about 1.25 inches. In at least one preferred embodiment, the dried sized glass fibers 56 are split into dried bundles of fibers 58 with a bundle tex of from about 20 to about 200 g/km, and preferably from about 30 to about 50 g/km. The dried, chopped glass fiber bundles 10 may fall onto a collection container 48 for storage or placed onto a conveyor for an in-line formation of a chopped strand mat (embodiment is not illustrated). In an alternate embodiment, the dried, chopped fiber bundles 10 may be placed onto a conveyor (not shown) for conveyance to a conventional dielectric (RF) oven, a fluidized bed oven such as a Cratec® oven (available from Owens Corning), or a rotary tray thermal oven to further dry fiber bundles 10.

In use, the dried chopped glass fiber bundles 10 may be used in a variety of compression and injection molding applications. For example, the chopped glass fiber bundles according to the present invention may be used in forming sheet molding compounds (SMC), in bulk molding compounds (BMC), in hand lay-up applications, in spray-up applications, in extrusion applications, in injection molding processes, in compression molding processes, and in rotational molding processes. In addition, the chopped glass fiber bundles 10 may be used to create composite articles and preforms that may be used in infusion molding applications such as resin transfer molding (RTM) and vacuum assisted resin transfer molding (VARTM) or in reaction injection molding applications such as reinforcement reaction injection molding (RRIM) and structural reaction injection molding (SRIM).

One example of utilizing the glass fiber bundles 10 is in compression molding a sheet molding compound (SMC) or bulk molding compound (BMC). Thus, in at least one aspect of the invention, the fiber bundles 10 may be advantageously employed as reinforcements in sheet molding compounds and bulk molding compounds. For example, in forming a sheet molding compound, the bundled glass fibers 10 may be placed onto a layer of a thermosetting polymer film, such as an unsaturated polyester resin or vinyl ester resin, positioned on a first carrier sheet that has a non-adhering surface. A second, non-adhering carrier sheet containing a second layer of a thermosetting polymer film may be positioned on the glass fiber bundles 10 in an orientation such that the second polymer film contacts the bundled glass fibers 10 and forms a sandwiched material of polymer film/bundled glass fibers/polymer film. The first and second thermosetting polymer film layers may contain a mixture of resins and additives such as fillers, pigments, UV stabilizers, catalysts, initiators, inhibitors, mold release agents, and/or thickeners. In addition, the first and second polymer films may be the same or they may be different from each other. This sandwiched material may then be kneaded with rollers such as compaction rollers to substantially uniformly distribute the polymer resin matrix and glass fiber bundles 10 throughout the resultant SMC material. As used herein, the term “to substantially uniformly distribute” means to uniformly distribute or to nearly uniformly distribute. The SMC material may then be stored for about 2-3 days to permit the resin to thicken and mature to a target viscosity.

A matured SMC material (i.e., an SMC material that has reached the target viscosity) or a bulk molding compound containing glass fiber bundles 10 may be molded in a compression molding process to form a composite product. The matured SMC material or a bulk molding compound material may be placed in one half of a matched metal mold having the desired shape of the final product. In compression molding sheet molding compounds, the first and second carrier sheets are typically removed from the matured SMC material and the matured SMC material may be cut into pieces having a pre-determined size (charge) which are placed into the mold. The mold is closed and heated to an elevated temperature and raised to a high pressure. This combination of high heat and high pressure causes the SMC or BMC material to flow and fill out the mold. The matrix resin then crosslinks or cures to form the final thermoset molded composite part.

The SMC material may be used to form a variety of composite products in numerous applications, such as in automotive applications including the formation of door panels, trim panels, exterior body panels, load floors, bumpers, front ends, underbody shields, running boards, sunshades, instrument panel structures, and door inners. In addition, the SMC material may be used to form basketball backboards, tubs and shower stalls, sinks, parts for agricultural equipment, cabinets, storage boxes, and refrigerated box cars. The bulk molding compound material may be used to form items similar to those listed above with respect to the SMC material, as well as items such as appliance cabinets, computer boxes, furniture, and architectural parts such as columns.

Alternatively, the glass fiber bundles 10 may be mixed with pellets of a thermoplastic polymer resin and supplied to an extruder where the resin is melted and a glass fiber bundle 10/resin dispersion is formed. The glass fiber bundle 10/resin dispersion may then be formed into pellets which may be fed to a compression molding apparatus and formed into molded composite articles such as are described above.

It is desirable that the glass fiber bundles 10 have bundle integrity when the metal die closes and is heated so that the sheet molding compound, bulk molding compound, or glass fiber bundle/resin pellets can flow and fill the die to form the desired part. The size on the glass fibers 12 maintains bundle integrity during processing and molding the sheet molding compound and bulk molding compound. However, if the glass fiber bundles 10 disassociate into single fibers within the die before the flow is complete, the individual glass fibers may form clumps and incompletely fill the die, thereby resulting in a defective part.

The glass fiber bundles 10 may also be utilized in injection molding applications. In general, injection molding is a closed-molding process where filled or unfilled polymer resins are injected into closed matched metal molds (e.g., tool). In at least one embodiment of the invention, the glass fiber bundles 10 are mixed with a thermoplastic polymer resin and placed into a chamber or barrel of an injection molding machine. The chamber (barrel) of the injection molding machine is heated to a temperature sufficient to melt the polymer resin. The melted resin/glass fiber bundle 10 mixture is then injected into a cooled, closed mold. After a sufficient period of time in the mold, the melted resin/glass fiber bundle 10 mixture cools and forms a solid polymeric article in the shape defined by the mold.

Alternatively, the glass fiber bundles 10 may mixed with a thermoset polymer, placed into the chamber of an injection molding machine, and heated to a temperature sufficient to melt the thermoset polymer resin. Unlike the thermoplastic polymeric articles described above, the formed composite article can be removed hot from the tool (i.e., the matched molds) as a vitrified, solid part due to the curing properties of the thermoset polymer.

In an alternate embodiment, a bulk molding compound containing the glass fiber bundles 10 may be injected into a heated mold by an injection molding machine to effect crosslinking and cure of the resin. BMC injection molding is advantageous in that it has a fast cycle time and can mold numerous parts with each injection. Thus, more final parts can be formed with a BMC material and manufacturing times can be increased.

The glass fiber bundles 10 may also be advantageously utilized in infusion molding applications such as resin transfer molding (RTM) and vacuum assisted resin transfer molding (VARTM) to make preforms and composite parts. In resin transfer molding, a thermosetting polymeric resin is injected into a closed mold cavity having a specific shape and/or dimension to make semi-structural and appearance parts. In particular, glass fiber bundles 10 formed in accordance with the present invention are placed in one half of a matched mold, the mold is closed and sealed, and the resin is slowly pumped (injected) into the mold. The resin may be injected under pressure. In at least one embodiment, the thermoset resin is heated in an injection molding apparatus (e.g., in the barrel) to melt or liquefy the thermosetting resin. Optionally, the mold may be heated, such as with hot water. The liquid thermosetting resin wets through the glass fiber bundles 10 and cures to form the final composite part. Infusion molding applications may be used to form large, high content structural composite parts such as boat hulls and windmill blades.

Resin infusion processes can also infuse resin into reinforcement materials with a vacuum, such as by VARTM, which may reduce potential air bubble entrapment. VARTM uses a single-sided rigid mold at least partially covered with the bundles of glass fibers 10. The mold is sealed with an impermeable film or flexible vacuum bag. A vacuum is drawn on the space between the mold containing the glass fiber bundles 10 and the seal. Atmospheric pressure provides both the compaction force on the mold and also the driving force for resin infusion from an external supply into the lower pressure cavity. A thermoset resin is pulled into the sealed bag by the vacuum pressure and the resin flows through the glass fiber bundles 10. The thermoset resin may be cured by placing the mold in an oven and heating the mold to a temperature high enough to crosslink (cure) the polymeric resin.

The glass fiber bundles 10 may also be utilized in reaction injection molding (RIM) applications, such as reinforcement reaction injection molding (RRIM) and structural reaction injection molding (SRIM). In reaction injection molding, the chopped glass fiber bundles 10 may be blended with a thermoset resin in a high pressure mix head and injected into heated, closed, matched metal molds. Alternatively, the glass fiber bundles 10 may be loaded into the closed mold and the thermoset resin may be dispensed into the glass fiber bundles 10 before the mold is closed or the resin may be injected into the mold after the mold is closed. Composite parts having excellent surface appearance and some structural properties such as automotive body panels may be formed by these reaction injection molding processes.

In spray-up applications, a layer formed of the glass fiber bundles 10 and a thermoset resin may be applied or deposited onto half of a mold to take the shape of the desired preform, such as a truck bed, boat hull, bath tub, or automobile door inner. The mold may be at least partially coated with a releasing agent, such as a wax, which will enable the part (e.g., preform) to be easily removed after the curing process has been completed. In addition, the mold may be pre-treated with a gel coat to assist with the easy removal of the preform and to permit for a smooth surface finish. The gel coat is desirably applied after the releasing agent and may be clear or pigmented. The glass fiber bundles 10 and the thermoset resin are preferably air-blown onto the mold halves such as by spraying the glass fiber bundles 10 and the resin (e.g., powder or liquid form) with a spraying apparatus. Approximately 70% by weight resin and approximately 30% by weight glass fiber bundles 10 may be applied to the mold. The resin/glass mixture may then be manually rolled out to remove air and smooth the mixture in the mold. The resin cures to form the preform, which is subsequently removed from the mold.

In another embodiment of the present invention, the glass fiber bundles 10 may be utilized in rotational molding. For example, the glass fiber bundles 10 may be placed in a mold together with a thermoplastic or thermoset resin and heated while rotating the mold. Centrifugal force pushes the resin into the glass bundles 10. When a thermoplastic resin is utilized, the mold must be cooled prior to removing the final composite part. Rotational molding may be used for the manufacture of hollow plastics such as large storage tanks, pipes for oil fields, and water conveyance and chemical processing equipment.

In large structural or semi-structural composite parts such as boat hulls and truck parts, it is desirable that the glass fiber bundles filamentize so that each individual glass fiber within the bundle can contribute to the overall laminate strength. In addition, by filamentizing the glass fiber bundles, wet-out of the glass fibers may occur more easily. Un-wet fibers may cause faults or defects within the laminate and may be a source for cracking or for the accumulation of water within the laminate, which may cause the laminate to blister and peel. Further, filamentizing the glass fiber bundles reduces the occurrence of and may even prevent “telegraphing” or “fiber print”, which is the outline of any un-wet fibers at the part surface and is an unwanted visual defect in the final part.

There are numerous advantages provided by the chopped glass fiber bundles 10 of the present invention. For instance, the chopped glass fiber bundles 10 may be formed at a significantly fast rate, especially when compared glass bundles formed by conventional air-laid processes. Increasing the rate of speed that the chopped glass fiber bundles can be produced permits for a higher throughput and additional product that can be sold to customers. In addition, the chopped glass fiber bundles 10 can be formed with low manufacturing costs since the fibers do not have to be dried and chopped in separate steps. For example, the chopped glass fibers bundles 10 may be formed in one step and dried in bulk form in a container that may then be shipped to mat making facilities or to customers that use the chopped glass fibers in compression or injection molding applications. Thus, there is a large financial advantage in that the chopped glass fiber bundles 10 can be made much less expensively utilizing the processes of the present invention than with conventional processes. It is a further advantage that the chopped glass fiber bundles 10 may be used directly in compression or injection molding applications without modification to the bundles.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

### Formation of Dry Chopped Glass Fiber Bundles

The sizing formulations set forth in Tables 1-4 were prepared in buckets as described generally below. To prepare the size compositions, approximately 90% of the water and, if present in the size composition, the acid(s) were added to a bucket. The silane coupling agent was added to the bucket and the mixture was agitated for a period of time to permit the silane to hydrolyze. After the hydrolyzation of the silane, the lubricant and film former were added to the mixture with agitation to form the size composition. The size composition was then diluted with the remaining water to achieve the target mix solids of approximately 4.5% mix solids.

TABLE 1
Polyurethane Size Composition A

| Component of Size | % by Weight of |
|---|---|
| Composition | Active Solids |
| W290H^{(a)} | 83.64 |
| A-187^{(b)} | 1.12 |
| A-1100^{(c)} | 4.68 |
| A-100^{(d)} | 9.95 |
| Lubesize K-12^{(e)} | 0.06 |

^{(a)}polyurethane film forming dispersion (Cognis)
^{(b)}epoxy curative (Resolution Performance Products)
^{(c)}γ-aminopropyltriethoxysilane (General Electric)
^{(d)}polyurethane-acrylic alloy (Cognis)
^{(e)}stearic ethanolamide (AOC)

TABLE 2
Polyurethane Size Composition B

| Component of Size | % by Weight of |
|---|---|
| Composition | Active Solids |
| W296^{(a)} | 89.22 |
| A-187^{(b)} | 1.19 |
| A-1100^{(c)} | 4.46 |
| PEG 400 MO^{(d)} | 3.93 |

^{(a)}polyurethane film forming dispersion (Chemtura)
^{(b)}epoxy curative (Resolution Performance Products)
^{(c)}γ-aminopropyltriethoxysilane (General Electric)
^{(d)}polyurethane-acrylic alloy (Cognis)
^{(e)}monooleate ester (Cognis)

TABLE 3
Epoxy Size Composition A

| Component of Size | % by Weight of |
|---|---|
| Composition | Active Solids |
| ER 5520^{(a)} | 46.15 |
| DPC-6870^{(b)} | 46.15 |
| PEG 400 MO^{(c)} | 3.08 |
| A-174^{(d)} | 4.62 |

^{(a)}epoxy resin film forming dispersion in water (Resolution Performance Products)
^{(b)}epoxy curative (Resolution Performance Products)
^{(c)}monooleate ester (Cognis)
^{(d)}methacryloxypropyltrimethoxysilane (General Electric)

TABLE 4
Epoxy Size Composition D

| Component of Size | % by Weight of |
|---|---|
| Composition | Active Solids |
| ER 3546^{(a)} | 47.20 |
| DPC-6870^{(b)} | 47.20 |
| PEG 400 MO^{(c)} | 0.88 |
| A-174^{(d)} | 4.72 |

^{(a)}epoxy resin film forming dispersion (Resolution Performance Products)
^{(b)}epoxy curative (Resolution Performance Products)
^{(c)}monooleate ester (Cognis)
^{(d)}methacryloxypropyltrimethoxysilane (General Electric)

Each of the sizes were applied to E-glass in a conventional manner (such as a roll-type applicator as described above. The E-glass was attenuated to 13 μm glass filaments in a 75 lb/hr throughput bushing fitted with 2052 hole tip plate. The filaments were gathered and split 16 ways to achieve 128 filaments per glass fiber bundle and a bundle tex of about 43 g/km. The glass fiber bundles were then chopped with a mechanical cot-cutter combination to a length of approximately 1 ¼ inches and gathered into a plastic pan. The chopped glass fibers contained approximately 15% forming moisture. This moisture in chopped glass fiber bundles was removed in a dielectric oven (40 MHz, Radio Frequency Co.) to form dried chopped glass fiber bundles.

### Example 2

### Formation of Dry Chopped Glass Fiber Bundles Utilizing a Heat Transfer Chamber

Each of the sizes set forth in Tables 1-4 were prepared and applied in a conventional manner to E-glass attenuated to 13 μm glass filaments in a 75 lb/hr throughput bushing fitted with 2052 hole tip plate. The sized fibers were split 16 ways to achieve 128 filaments per glass fiber bundle and passed through a heat transfer chamber where air heated by the extreme heat generated by the bushing was drawn into the heat transfer chamber to dry the glass fiber bundles. The dried glass fiber bundles had a bundle tex of about 43 g/km. The dried glass fiber bundles were gathered into one tow and chopped with a mechanical cot-cutter combination to a length of 1 ¼ inches. The chopped glass fibers were gathered into a plastic pan. The glass fibers contained 0% forming moisture.

### Example 3

### Formation of Bulk Molding Compound Utilizing Various Sizing Compositions

One quarter inch (¼″) chopped glass fiber samples were made into bulk molding compounds with the formulation set forth in Table 5.

TABLE 5
Bulk Molding Compound Formulation

| | pph |
|---|---|
| Component | (Parts Per Hundred) |
| Polyester Resin E-342^{(a)} | 60 |
| Thermoplastic P-713^{(b)} | 40 |
| tBPB^{(c)} | 1.5 |
| Calwhite II^{(d)} | 200 |
| Zinc Stearate^{(e)} | 4 |

^{(a)}unsaturated polyester resin (AOC)
^{(b)}thermoplastic (AOC)
^{(c)}tert-butylperbenzoate catalyst
^{(d)}calcium carbonate (Cabot)
^{(e)}mold release agent (Aldrich Chemical Co.)

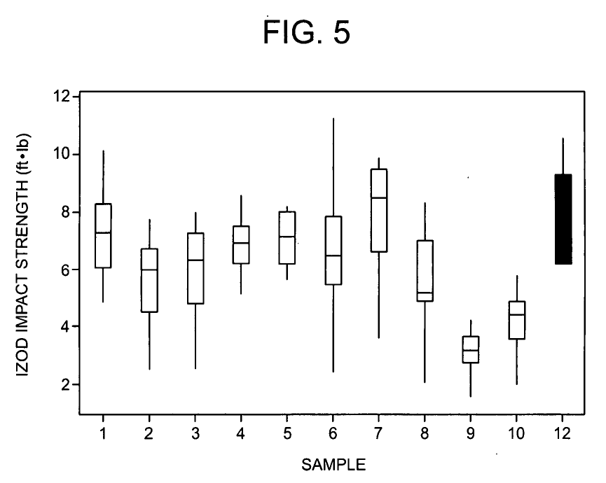

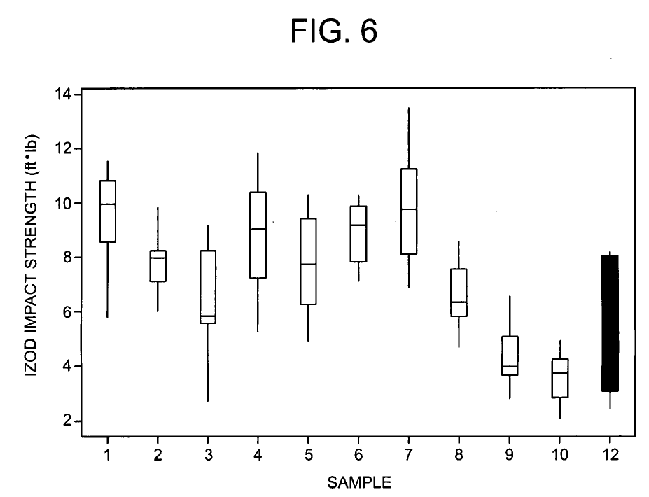

The bulk molding compound formulation in Table 5 was prepared with various experimental glasses sized with the various sizing compositions at 20% by weight. The various experimental glass fibers are set forth below as Samples 1-10. The charge was placed into a 12 inch×18 inch tool and was molded at 10,000 psi at 265° F. for 5 minutes. The laminates were tested for resistance to notched impact strength according to ASTM D256 in the 0° and 90° direction. The results are set forth in FIGS. 5 and 6. The results indicated that the glass fibers sized with the experimental size composition demonstrated at least comparable performance to the control. The results were unexpected because an at least comparable impact strength was achieved by drying the glass fibers for a short period of time (30 minutes) as compared to conventional processes in which the glass is thermally dried for at least 20 hours.

Sample 1—Polyurethane Size Composition A (Table 1) was applied to glass fibers and dried for 6 hours a thermal oven at 265° F.

Sample 2—Polyurethane Size Composition A (Table 1) was applied to glass fibers and dried for 30 minutes in an RF oven followed by 1 hour in a thermal oven at 265° F.

Sample 3—Polyurethane Size Composition A (Table 1) was applied to glass fibers and dried for 30 minutes in an RF oven followed by 2 hours at in a thermal oven at 265° F.

Sample 4—Polyurethane Size Composition A (Table 1) was applied to glass fibers and dried for 30 minutes in an RF oven followed by 2 hours in a thermal oven at 265° F.

Sample 5—Polyurethane Size Composition A (Table 1) was applied to glass fibers and dried for 30 minutes in an RF oven followed by 2 hours in a thermal oven at 265° F.

Sample 6—Polyurethane Size Composition A (Table 1) was applied to glass fibers and dried for 30 minutes in an RF oven followed by 2 hours in a thermal oven at 265° F.

Sample 7—Polyurethane Size Composition B (Table 2) was applied to glass fibers and dried for 30 minutes in an RF oven; no post heating.

Sample 8—Epoxy Size Composition A (Table 3) was applied to glass fibers and dried for 30 minutes in an RF oven; no post heating.

Sample 9—Epoxy Size Composition A (Table 3) was applied to glass fibers and dried for 20 minutes in an RF oven; no post heating.

Sample 10—Polyurethane Size Composition B (Table 2) was applied to glass fibers and dried for 20 minutes in an RF oven; no post heating.

Sample 12—control bulk molding compound (BMC) dry use chopped strands (101C from Rio Claro, Brazil; Owens Coming).

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A method of making a molded composite article comprising the steps of:
placing chopped glass fiber bundles and a molding compound containing a polymeric resin into a half of a matched mold, said chopped glass fiber bundles having a plurality of substantially parallel glass fibers positioned in a bundled orientation, said glass fibers being at least partially coated with a size composition that maintains said plurality of glass fibers in said bundled orientation during the formation and subsequent processing of said glass fiber bundles;
closing said matched mold;
heating said closed matched mold under pressure to a temperature sufficient to cause said molding compound to melt; and
curing said polymeric resin to form a composite article;
wherein said size composition includes:
one or more film forming agents selected from the group consisting of a polyurethane film former, an unsaturated polyester film former and an epoxy resin film former;
at least one silane coupling agent; and
at least one lubricant.

2. The method of claim 1, wherein said molding compound is selected from the group consisting of a sheet molding compound material and a bulk molding compound material.

3. The method of claim 2, further comprising the steps of:
applying said size composition to a plurality of glass fibers attenuated from a bushing;
splitting said plurality of glass fibers into glass fiber strands having a predetermined number of said glass fibers therein;
chopping said glass fiber strands to form wet chopped glass fiber bundles, said wet chopped glass fiber bundles having a discrete length; and
drying said wet chopped glass fiber bundles in a drying oven selected from the group consisting of a dielectric oven, a fluidized bed oven and a rotating tray thermal oven to form said chopped glass fiber bundles.

4. The method of claim 2, further comprising the steps of:
applying said size composition to a plurality of glass fibers attenuated from a bushing;
splitting said plurality of glass fibers into glass fiber strands having a predetermined number of said glass fibers therein;
chopping said glass fiber strands to form wet chopped glass fiber bundles, said wet chopped glass fiber bundles having a discrete length;
collecting said wet chopped glass fiber bundles in a container; and
drying said wet chopped glass fiber bundles in said container in a drying oven selected from the group consisting of a dielectric oven, a fluidized bed oven and a rotating try thermal oven to form said chopped glass fiber bundles.

5. The method of claim 2, further comprising the step of forming said chopped glass fiber bundles, said step of forming said chopped glass fiber bundles including:
applying said size composition to a plurality of glass fibers attenuated from a bushing;
passing said plurality of glass fibers through a heat transfer chamber where air heated by said bushing is drawn into said heat transfer chamber to substantially dry said plurality of sized glass fibers and form dried glass fibers;
splitting said dried glass fibers into glass fiber strands having a predetermined number of said dried glass fibers therein; and
chopping said glass fiber strands to form said chopped glass fiber bundles.

6. The method of claim 1, wherein said film forming agent is a polyurethane film forming agent and said size composition further comprises a polyurethane-acrylic alloy.

7. The method of claim 1, wherein said film forming agent is an epoxy resin film former and said size composition further comprises an epoxy curative.

8. The method of claim 1, wherein said one or more film forming agents are present in said size composition in an amount of from about 15 to about 95% by weight of the active solids, said at least one silane coupling agent is present in said size composition in an amount of from about 1.5-15% by weight of the active solids, and said at least one lubricant is present in said size composition in an amount of from about 0.05 to about 10% by weight of the active solids.

9. A method of forming a molded composite article comprising the step of:
molding chopped glass fiber bundles and a polymeric material selected from the group consisting of a resin and a resin-containing compound in a mold having two halves such that when said two halves are positioned together they form a closed mold having a desired shape;
wherein at least one of said chopped glass fiber bundles, said resin, and said resin-containing compound is injected into said closed mold;
wherein said chopped glass fiber bundles are formed of a plurality of substantially parallel glass fibers positioned in a bundled orientation, said glass fibers being at least partially coated with a size composition that maintains said plurality of glass fibers in said bundled orientation during the formation and subsequent processing of said glass fiber bundles; and
wherein said sizing composition includes:
one or more film forming agents selected from the group consisting of a polyurethane film former, an unsaturated polyester film former and an epoxy resin film former;
at least one silane coupling agent; and
at least one lubricant.

10. The method of claim 9, wherein said polymeric material is a thermoplastic resin and said molding step comprises:
heating said chopped glass fiber bundles and said thermoplastic resin to a temperature sufficient to place said thermoplastic resin in a molten state and form a liquid resin/glass fiber bundle mixture;
injecting said liquid resin/glass fiber bundle mixture into said closed mold,; and
cooling said liquid resin/glass fiber bundle mixture to form said molded composite article.

11. The method of claim 9, wherein said polymeric material is a thermosetting resin and said molding step comprises:
heating said chopped glass fiber bundles and said thermosetting resin to a temperature sufficient to place said thermosetting resin in a molten state and form a liquid resin/glass fiber bundle mixture;
injecting said liquid resin/glass fiber bundle mixture into said closed mold; and
curing said thermosetting resin to form said molded composite article.

12. The method of claim 9, wherein said polymeric material is a bulk molding compound and said molding step comprises:
heating said closed mold;
injecting said bulk molding compound and said chopped glass fiber bundles into said heated closed mold; and
curing said thermosetting resin to form said molded composite article.

13. The method of claim 9, wherein said polymeric material is a thermosetting resin and said molding step comprises:
placing said chopped glass fiber bundles in one half of said two halves of said mold;
positioning said two halves of said mold such that said mold is in said closed configuration;
injecting said thermosetting resin into said closed mold to wet said chopped glass fiber bundles with said thermosetting resin; and
curing said thermosetting resin to form said molded composite article.

14. The method of claim 9, wherein said polymeric material is a thermosetting resin and said molding step comprises:
mixing said chopped glass fiber bundles and said thermosetting resin under high pressure to form a resin/glass fiber bundle mixture;
injecting said resin/glass fiber bundle mixture into said closed mold, said closed mold being heated to a temperature sufficient to melt said thermosetting resin; and
curing said thermosetting resin to form said composite article.

15. The method of claim 9, wherein said polymeric material is a resin selected from the group consisting of a thermosetting resin and a thermoplastic resin and said molding step comprises:
placing said chopped glass fiber bundles and said resin in said closed mold;
heating said closed mold;
rotating said closed mold, said rotation of said closed mold causing centrifugal force to be placed on said chopped glass fiber bundles and said resin to disperse said resin throughout said chopped glass fiber bundles and form a mixture; and
curing said mixture to form said molded composite article.

16. The method of claim 9, further comprising the steps of:
applying said size composition to a plurality of glass fibers attenuated from a bushing;
splitting said plurality of glass fibers into glass fiber strands having a predetermined number of said glass fibers therein;
chopping said glass fiber strands to form wet chopped glass fiber bundles, said wet chopped glass fiber bundles having a discrete length; and
drying said wet chopped glass fiber bundles in a drying oven selected from the group consisting of a dielectric oven, a fluidized bed oven and a rotating tray thermal oven to form said chopped glass fiber bundles.

17. The method of claim 9, further comprising the steps of:
applying said size composition to a plurality of glass fibers attenuated from a bushing;
splitting said plurality of glass fibers into glass fiber strands having a predetermined number of said glass fibers therein;
chopping said glass fiber strands to form wet chopped glass fiber bundles, said wet chopped glass fiber bundles having a discrete length;
collecting said wet chopped glass fiber bundles in a container; and
drying said wet chopped glass fiber bundles in said container in a drying oven selected from the group consisting of a dielectric oven, a fluidized bed oven and a rotating try thermal oven to form said chopped glass fiber bundles.

18. A method of forming a preform for a composite article comprising the steps of:
air-blowing chopped glass fiber bundles and a thermosetting resin into one half of a matched mold, said matched mold being formed of two halves such that when said two halves are positioned together they form a desired shape of a composite article, said chopped glass fiber bundles having a plurality of substantially parallel glass fibers positioned in a bundled orientation, said glass fibers being at least partially coated with a size composition that includes:
one or more film forming agents selected from the group consisting of a polyurethane film former, an unsaturated polyester film former and an epoxy resin film former;
at least one silane coupling agent; and
at least one lubricant; and
curing said thermosetting resin to form said preform for said composite article.

19. The method of claim 18, further comprising the steps of:
applying said size composition to a plurality of glass fibers attenuated from a bushing;
splitting said plurality of glass fibers into glass fiber strands having a predetermined number of said glass fibers therein;
chopping said glass fiber strands to form wet chopped glass fiber bundles, said wet chopped glass fiber bundles having a discrete length;
collecting said wet chopped glass fiber bundles in a container; and
drying said wet chopped glass fiber bundles in said container in a drying oven selected from the group consisting of a dielectric oven, a fluidized bed oven and a rotating try thermal oven to form said chopped glass fiber bundles.

20. The method of claim 18, further comprising the steps of:
applying said size composition to a plurality of glass fibers attenuated from a bushing;
passing said plurality of glass fibers through a heat transfer chamber where air heated by said bushing is drawn into said heat transfer chamber to substantially dry said plurality of sized glass fibers and form dried glass fibers;
splitting said dried glass fibers into glass fiber strands having a predetermined number of said dried glass fibers therein; and
chopping said glass fiber strands to form said chopped glass fiber bundles.
